(19) United States
(12) Patent Application Publication
(10) Pub. No.: US 2013/0000948 A1
(43) Pub. Date: Jan. 3, 2013

(54) ELECTRICAL CABLE

(76) Inventors: Giovanni Joseph Ida Henssen, Born (NL); Hans Schneiders, Gulpen (NL)

(21) Appl. No.: 13/515,955

(22) PCT Filed: Dec. 17, 2010
(86) PCT No.: PCT/EP2010/070108

§ 371 Date: Aug. 31, 2012

(30) Foreign Application Priority Data
Dec. 17, 2009 (EP) 09179617.7

(51) Int. Cl. H01B 3/30

(52) U.S. Cl. 174/110 SR

(57) ABSTRACT

The invention relates to a cable suitable to send electrical signals, said cable having a diameter of at most 10 mm and comprising a protective cover, wherein said cover comprises high strength polyolefin fibers and wherein the thickness of the cover is at most 10% of the diameter of the cable.

The invention relates to a cable and particularly to a plastic insulated cable such as an electrical or an optical cable, said cable having a diameter of at most 10 mm and comprising a protective cover.

An example of such a cable is given by U.S. Pat. No. 4,326,094 wherein an electrical cable comprising polyethylene insulated copper wires enclosed by a water proof cover is disclosed.

It was observed that in particular for thin cables, i.e. cables having a diameter of less than 10 mm, the flexibility thereof is reduced when protective covers are used for improving said cables.

It is therefore an aim of the present invention to provide a thin cable having a protective cover, said cable having a good flexibility.

The invention provides a cable suitable to send electrical signals, said cable having a diameter of at most 10 mm and comprising a protective cover, said cover comprising high strength polyolefin fibers and wherein the thickness of the cover is at most 10% of the diameter of the cable.

It was observed that the cable of the invention has a good flexibility comparable with the flexibility of the cable without the protective cover. In particular the cable of the invention has a good resistance against self-entangling during its utilization, i.e. resistance to the formation of loops and knots along the length of the cable.

It was also observed that the cable of the invention showed good resistance to wearing, cutting and tearing in particular when impacted by the rotating drill, of a drilling machine or a shovel.

It was also observed that the cable of the invention had a reduced coefficient of friction which has proven beneficial during cable manipulation wherein the cable was pulled through e.g. pipes or rings.

Electrical or optical cables usually consist of a plurality of separately insulated optical or electrical conductors, located within a plastic sheath. Such cables are well known in the art. Thus, according to the invention, a cable suitable to send electrical signals is meant to include a cable comprising one or more electrical or optical conductors. An example of an electrical conductor is a copper wire or a bundle of copper wires. An example of an optical conductor is a glass fiber or bundle of glass fibers.

Preferably the diameter of the cable of the invention is at most 5 mm, more preferably at most 3 mm. Preferably, said diameter is between 0.3 mm and 5 mm, more preferably between 0.4 mm and 3 mm. By diameter of the cable is herein understood the largest distance between two points located on the perimeter of a cross section of said cable. Preferably, the cable has a circular cross-section.

By protective cover is herein understood a cover which protects the cable from outside factors which might have detrimental effects of the cable. Good results for the cable of the invention were obtained when the protective cover forms the exterior of the cable, i.e. the polyolefin fibers are exposed to the surrounding environment.

In a preferred embodiment of the cable of the invention, the protective cover is braided from polyolefin fibers. Preferably the braiding is carried out with between 1 and 50 stitches (also known as picks) per cm, more preferably between 5 and 30, most preferably between 7 and 20 stitches per cm. It was observed that such a braided cover has little influence on increasing the flexibility of the cable.

In another preferred embodiment of the cable of the invention, the protective cover is a woven cover. Any woven structure can be used, e.g. a plain weave, rib, matt weave and twill weave fabrics and the like.

In yet another preferred embodiment of the cable of the invention, the protective cover is a 3D hollow cover. Such hollow cover can be made with a multi-layer flat weaving technique wherein the layers are connected at the edges to form the wall of a tubular construction. The hollow cover may also be made with a circular (or round) weaving technique or circular knitting technique. All these above-mentioned techniques used to manufacture hollow covers are well known in the art. It was observed that such a hollow cover can be easily installed on any common electrical or optical cable by simply pulling it onto the cable.

An advantageous cable of the invention was obtained when the thickness of the protective cover is at most 5%, preferably at most 3%.

According to the invention, the protective cover comprises high strength polyolefin fibers. High strength fibers are herein understood fibers having a tensile strength of preferably at least 10 g/den, more preferably at least 20 g/den, most preferably at least 30 g/den. The modulus of said fibers is preferably at least 250 g/den, more preferably at least 500 g/den. The tensile strength and the modulus of the fibers have been defined and are determined as described in ASTM D885 M using a nominal gauge length of the fiber of 500 mm, a crosshead speed of 50%.min and Instron 2714 clamps. The fiber is twisted before the measurement at 31 turns/meter. On the basis of a measured stress-strain curve the modulus is determined as the gradient between 0.3 and 1% strain.

By fiber is herein understood an elongated body having a length dimension much greater that the fiber's transverse dimensions, e.g. of width and thickness. The term fiber also includes various embodiments e.g. a filament, a ribbon, a strip, a band, a tape and the like having regular or irregular cross-sections. The fiber may have a continuous length (also known as filament) or discontinuous lengths (also known as staple fiber).

Preferably, the titer of the fibers is at most 25 denier, more preferably at most 15 denier per individual fiber, more preferably at most 5 denier per individual fiber. It was observed that good results in terms of cable flexibility were obtained by using low denier fibers. If yarns, e.g. an elongated body comprising a plurality of fibers, are used, the yarn titer is preferably at most 1000 dtex, more preferably at most 750 dtex, even more preferably at most 500 dtex, most preferably at most 300 dtex. Preferably the yarns having the above mentioned titers contain continuous fibers, i.e. filaments.

According to the invention, the fibers in the protective sheath are polyolefin fibers. Preferably, said fibers are fibers of polyethylene or polypropylene.

Preferred polyethylene fibers are high molecular weight polyethylene (HMWPE) fibers and ultrahigh molecular weight polyethylene (UHMWPE) fibers. Said polyethylene fibers may be manufactured by any technique known in the art, preferably by a melt or a gel spinning process. Most preferred fibers are gel spun UHMWPE fibers, e.g. those sold by DSM Dyneema under the name Dyneema®. If a melt spinning process is used, the polyethylene starting material used for manufacturing thereof preferably has a weight-average molecular weight between 20,000 and 600,000, more preferably between 60,000 and 200,000. An example of a melt spinning process is disclosed in EP 1,350,868 incorporated herein by reference. If the gel spinning process is used to manufacture said fibers, preferably an UHMWPE is used with an intrinsic viscosity (IV) of preferably at least 3 dl/g, more preferably at least 4 dl/g, most preferably at least 5 dl/g. Preferably the IV is at most 40 dl/g, more preferably at most 25 dl/g, more preferably at most 15 dl/g. Preferably, the UHMWPE has less than 1 side chain per 100 C atoms, more preferably less than 1 side chain per 300 C atoms. Preferably the UHMWPE fibers are manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7.

The protective cover may contain other fibers such as fibers manufactured from polyamides and polyaramides, e.g. poly(p-phenylene terephthalamide) (known as Kevlar®); poly(tetrafluoroethylene) (PTFE); poly{2,6-diimidazo[4,5b-4′,5′e]pyridinylene-1,4(2,5-dihydroxy)phenylene}(known as M5); poly(p-phenylene-2,6-benzobisoxazole) (PBO) (known as Zylon®); poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyvinyl alcohols; and thermotropic liquid crystal polymers (LCP) as known from e.g. U.S. Pat. No. 4,384,016. Also combinations of fibers manufactured from the above referred polymers can be used in the rope of the invention.

The protective cover may also contain a plastomer. Preferably the fibers are coated with said plastomer. Alternatively the protective cover can be impregnated with said plastomer.

The plastomer can be present over the entire length of the cable, but can also be partially cover the cable. In a preferred embodiment, the plastomer is present on the cover at one or both outer ends of the cable. The plastomer then serves to connect any electrical or other connectors to the cable.

The plastomer is preferably a plastic material that belongs to the class of thermoplastic resins. Preferably, said plastomer is a semi-crystalline copolymer of ethylene or propylene and one or more C2 to C12 α-olefin co-monomers manufactured by a single site catalyst polymerization process, said plastomer having a density of between 880 and 930 kg/m³. Most preferably said plastomer is a metallocene plastomer, i.e. a plastomer manufactured by a metallocene single site catalyst. Ethylene is in particular the preferred co-monomer in copolymers of propylene while butene, hexene and octene are being among the preferred α-olefin co-monomers for both ethylene and propylene copolymers.

In a preferred embodiment, the plastomer is a thermoplastic copolymer of ethylene or propylene and containing as co-monomers one or more α-olefins having 2-12 C-atoms, in particular ethylene, isobutene, 1-butene, 1-hexene, 4-methyl-1-pentene and 1-octene. When ethylene with one or more C3-C12 α-olefin monomers as co-monomers is applied, the amount of co-monomer in the copolymer usually is lying between 1 en 50 wt.%, and preferably between 5 and 35 wt. %. In case of propylene copolymers, the amount of co-monomers and in particular of ethylene co-monomers, usually is lying between 1 en 50 wt.%, and preferably between 2 and 35 wt%, more preferably between 5 and 20 wt.%. Good results in terms of shrinkage were obtained when the density of the plastomer is between 880 and 920 kg/m³, more preferably between 880 and 910 kg/m³.

Preferably the plastomer has a DSC peak melting point as measured according to ASTM D3418 DSC of between 70° C. and 120° C., more preferably between 75° C. and 100° C., most preferably between 80° C. and 95° C.

Suitable plastomers that may be used in the rope of the invention and obtained with the metallocene catalyst type are manufactured on a commercial scale, e.g by Exxon, Mitsui, DEX-Plastomers and DOW under brand names as Exact, Tafmer, Exceed, Engage, Affinity, Vistamaxx and Versify. A description of plastomers and in particular of metallocene plastomers as well as an overview of their mechanical and physical properties can be found for instance in Chapter 7.2 of “Handbook of polypropylene and polypropylene composites” edited by Harutun G. Karian (ISBN 0-8247-4064-5) and more in particular in subchapters 7.2.1; 7.2.2; and 7.2.5 to 7.2.7 thereof, which are included herein by reference.

The fibers in the protective cover of the cable of the invention may be also coated with other polymeric material, more preferably an elastomer based material, said fiber being preferably coated prior to manufacturing the protective cover. A wide variety of elastomeric materials can be used for example polybutadiene, polyisoprene, natural rubber, ethylene-propylene copolymers, polyurethane elastomers, polyacrylates, polyesters, polyethers, silicone based elastomers, thermoplastic elastomers, copolymers of ethylene and the like.

The fibers in the protective cover of the cable are preferably coated with a fluoropolymer. Example of fluoropolymers (also known as fluorinated polymers) include both fluoroplastics (also known as fluorothermoplastics) and fluoroelastomers (or fluororubbers). Fluoropolymers for example include both vinylidene fluoride containing fluoropolymers and substantially non-vinylidene fluoride containing fluoropolymers and mixtures thereof. Blends of various fluoropolymers may be employed in the invention if desired. Examples of fluoropolymers can be found in U.S. Pat. No. 6,346,328 from line 34 of column 3 to line 61 of column 5, the disclosure of which is included herein by reference. Further examples of fluoropolymers include polytetrafluoroethylene (PTFE), e.g. Teflon® from DuPont; perfluoroalkoxy polymer resin (PFA); fluorinated ethylene-propylene (FEP); polyethylenetetrafluoroethylene (ETFE) e.g. Tefzel® from DuPont or Fluon® from Asahi Glass Company; polyvinylfluoride (PVF), e.g. Tedlar® from DuPont; polyethylenechlorotrifluoroethylene (ECTFE), e.g. Halar® from Solvay Solexis; polyvinylidene fluoride (PVDF), e.g. Kynar® from Arkema; polychlorotrifluoroethylene (PCTFE); designation (FFKM), e.g. Kalrez® from DuPont, Tecnoflon® from Solvay Solexis; (FPM/FKM), e.g. Viton® from DuPont.

Most preferred is a polytetrafluoroethylene (PTFE) coating.

The coating can also contain further constituents to increase binding of the coating to the cover comprising high strength polyolefin fibers or to improve abrasion resistance, preferred examples of such constituents are silicone based polymers and polyurethanes. According to a preferred embodiment the coating comprises a combination of a fluoropolymer, a silicone based polymer and a polyurethane.

The proportion of the coating on the fibers may vary from small amount ,e.g. about 1% by weight of the fibers to relatively large amounts, e.g. 150% by weight of the fibers. Useful amounts of coatings based upon the weight of the fiber range from 1 to 30, preferably 2 to 10% by weight of the fibers.

The coating can be applied to the fibers before making the cover, but the coating can also be applied on the cover after it has been braided, knitted or woven. A preferred way of applying the coating is a process where the cable comprising the protective cover comprising high strength polyolefin fibers is dipped in a bath containing the coating. The residence time in the bath should be such that the coating penetrates the cover sufficiently.

It was observed that the cable of the invention also shows good UV resistance. Furthermore, the dielectric breakdown threshold for the cable of the invention is reduced.

The cable of the invention can be used in a variety of applications, e.g. telephone cables, optical cables for data transmission, headphone cables, power supply cables and the like. The invention therefore relates also to such applications comprising the cable of the invention.

The invention will be furthermore explained with the help of the following examples, without being however limited thereto.

### EXAMPLES

A standard electrical cable having a diameter of 2 mm and containing a copper wire with a diameter of 1 mm, was covered with a braided protective cover. Said cover was braided from yarns containing ultrahigh molecular weight polyethylene fibers known as SK75 from DSM Dyneema®.

### Example 1

Three cables were produced with the difference that the titer of the yarns used to braid the cover was 110, 220, and 440 dtex for each cable respectively.

A fourth cable was produced wherein the braided cover was manufactured from a yarn of SK75 and a yarn of Black Polyester of 265 dtex.

All braids had 8 stitches per centimeter in an 1×1 tandem construction.

### Example 2

A set of cables was produced in the same manner as in Example 1 with the difference that the braids had 16 stitches per cm.

### Example 3

A set of cables was produced in the same manner as in Example 1 with the difference that the braids had a 2×1 normal construction.

### Example 4

A set of cables was produced in the same manner as Example 3 with the difference that the braids had 16 stitches per centimeter.

All cables had good flexibility, wear resistance and cut resistance. Furthermore, all cables had a low tendency to self-entangle.

### Example 5

Each cable of Example 1 was led through a bath containing an aqueous dispersion of PTFE. The dispersion is commercially known under the name of Etemitex® (code 69-000/D7977) and manufactured by Whitford.

The fibers were coated by dipping them in a water bath containing said dispersion in a ratio water:dispersion of 1:1, total concentration of solids (by weight) in the dipping solution of about 10%. The amount of composition per cable was about 7 mass% based on the total weight of the cable.

1. A cable suitable to send electrical signals, said cable having a diameter of at most 10 mm and comprising a protective cover, characterized in that said cover comprises high strength polyolefin fibers and wherein the thickness of the cover is at most 10% of the diameter of the cable.

2. The cable of claim 1, wherein the diameter of the cable is between 0.1 mm and 5 mm.

3. The cable of claim 1, wherein the polymeric fibers are ultrahigh molecular weight polyethylene fibers.

4. The cable of claim 1, wherein the cover forms the exterior of the cable.

5. The cable of claim 1, wherein the cover is braided.

6. The cable of claim 1, wherein the cover is round woven.

7. The cable of claim 1, wherein the cover is round knitted.

8. The cable of claim 1, wherein the cover contains a plastomer.

9. The cable of claim 1, wherein the high strength polyolefin fibers in the cover further comprise a coating.

10. The cable according to claim 9, wherein the coating comprises a fluoropolymer, preferably polytetrafluoroethylene (PTFE).
